(19) United States
(12) Patent Application Publication
(10) Pub. No.: US 2023/0271866 A1
(43) Pub. Date: Aug. 31, 2023

(54) METHOD AND DEVICE FOR TREATING ORGANIC WASTE, INCLUDING THE ANAEROBIC DIGESTION THEREOF AND THE COMPOSTING OF THE DIGESTATES

(71) Applicant: JUA, MONTPELLIER CEDEX 2 (FR)

(72) Inventor: Jean-Luc SALLUSTRO, EAU BLEUE (MU)

(73) Assignee: JUA, MONTPELLIER CEDEX 2 (FR)

(21) Appl. No.: 18/005,603

(22) PCT Filed: Jul. 15, 2021
(86) PCT No.: PCT/IB2021/056395

§ 371 Date: Jan. 14, 2023

(30) Foreign Application Priority Data
Jul. 16, 2020 (FR) 2007468

(51) Int. Cl. C02F 11/04

(52) U.S. Cl. CPC C02F 11/04; C02F 2101/30

(57) ABSTRACT

The invention relates to a continuous process for treating organic waste taking place in a plant, said process for treating organic waste comprising a process of anaerobic digestion of a first part of said waste, which takes place in at least one digestion chamber, and a process of aerobic composting of a second part of said waste, which takes place in at least one composting chamber, the process for treating organic waste comprising the steps of:—collecting digestate and biogas at the end of said anaerobic digestion process,—collecting compost and humic percolate at the end of said aerobic composting process,—feeding at least part of said digestate

### CROSS-REFERENCE TO RELATED APPLICATION

The present application is a National Stage Application of PCT International Application No. PCT/IB2021/056395 (filed on Jul. 15, 2021), under 35 U.S.C. § 371, which claims priority to French Patent Application No. FR 2007468 (filed on Jul. 16, 2020), which are each hereby incorporated by reference in their complete respective entireties.

### TECHNICAL FIELD

The present invention relates to the field of biological treatment of volatile or non-volatile organic matters and wastes. These organic matters and wastes can have various origins, such as slaughterhouse, kitchen and table wastes, plants or ligneous products of agricultural, forestry or industrial origin. They can be liquid such as blood or scrap from the dairy or wine industry, or solid such as viscera, spent grains, marc or the fermentable fraction of household wastes and the same. More specifically, the invention relates to anaerobic digestion processes as well as aerobic composting processes for organic matters, but above all the coupling of these two treatment modes on a single station.

Hence, the invention relates to a new process which couples in a single device a methanation process and a process for composting organic matters and wastes. The invention also relates to a new device for implementing this process.

### BACKGROUND

WIPO Patent Publication No. WO 2017/109398 (JUA Group) describes a plant and a process for the biological treatment of organic wastes and effluents by biodigestion. It is known that the treatment of organic matters by biodigestion is above all subjected to bacterial ecology constraints which the techniques used to create and maintain a favorable ecosystem for the micro-organisms specific to this type of bio-oxidation attempt to meet. Thus, a biodigester is a reactor that accommodates and maintains populations of strictly anaerobic microbes that are brought to grow and to multiply on an organic substrate formed by liquid or solid matters in the presence of water. These particular microbial populations essentially develop a bio-oxidation activity, but in the absence of air oxygen. The reaction is possible only when the three bacterial communities typical of this trophism form a balanced ecosystem such that the major portion of the reducing equivalents (carbon and hydrogen atoms) produced as wastes during the bacterial anabolism (hydrolysis, acidogenesis and acetogenesis) ultimately end up in methane (CH₄, methanogenesis).

The concerned bacterial species are complex and relatively varied, but their biochemical characteristics and the major features of their ecology are known quite well. They are generally classified into three groups: hydrolytic and fermentative bacteria, acetogenic bacteria, and methanogenic bacteria.

The management of the artificial ecosystem constituted by an anaerobic bioreactor requires dynamic intervention to ensure some essential physico-chemical conditions; such as pH, temperature and oxidation/reduction potential and nutritional requirements. The availability of digestible carbon is particularly critical to avoid fatal inhibitions in the presence of volatile fatty acids (commonly abbreviated VFAs) or supernumerary ammonium and to optimize methane production.

The critical parameters in the conduct of the anaerobic biodigestion process are pH, temperature, oxidation/reduction potential, and nutritional and metabolic supply.

The optimum pH of the anaerobic digestion is around neutrality. It is the result of the optimum pH of each bacterial population; that of the acidifying bacteria is between 5.5 and 6, acetogens prefer a pH close to neutrality whereas methanogens have maximum activity in a pH range comprised between 6 and 8. Nonetheless, the methanation can occur in slightly acidic or alkaline media.

The activity of the methanogenic consortium is closely related to temperature. Two optimum temperature ranges can be defined: the mesophilic area (between 35° C. and 38° C.) and the thermophilic area (between 55° C. and 60° C.) with a decrease in activity on either side of these temperatures. Most bacterial species have been isolated in mesophilic environments, but all trophic groups of the anaerobic digestion steps have thermophilic species using the same metabolic routes as the mesophilic bacteria with similar or higher performances. Nevertheless, it is possible to work at temperatures different from the optimums with lower performances.

The oxidation/reduction potential represents the reduction state of the system, it affects the activity of methanogenic bacteria. Indeed, besides the absence of oxygen, these bacteria require an oxidation/reduction potential lower than 330 mV to initiate their growth. The Redox potential (Eh) is an indicator of the bioelectric activity of a natural environment; the lower it is the more it indicates a high level of energy available for biochemical exchanges in the considered environment. The humic substances positively influence the redox potential.

As regards the nutritional and metabolic needs, like any micro-organism, each bacterium forming the methanogenic flora requires a sufficient supply of macro-elements (C, N, P, S) and trace elements for its growth. The needs in macro-elements can be assessed roughly starting from the raw formula describing the composition of a cell (C₅H9O₃N). For methanogenic bacteria, the culture medium must have carbon contents (expressed in Chemical Oxygen Demand (COD), nitrogen and phosphorus at least in the COD/N/P proportions equal to 400/7/1. Ammonium is their main source of nitrogen. Some species fix the molecular nitrogen while others require amino acids. The needs in nitrogen represent 11% of the volatile dry mass of the biomass and the needs in phosphorus ⅕ of those of nitrogen.

Methanogenic bacteria have high levels of Fe-S proteins which play an important role in the electron transport system and in the synthesis of coenzymes. Also, the optimum concentration of sulfur varies from 1 to 2 mM (mmol/L) in the cell. This flora generally uses reduced forms such as hydrogen sulfide. Methanogens assimilate phosphorus in mineral form.

Some trace elements are necessary for the growth of methanogens. These are more particularly nickel, iron and cobalt. Indeed, they are constituents of coenzymes and proteins involved in their metabolism. Magnesium is essential since it comes into play in the terminal reaction of methane synthesis as well as sodium appearing in the chemo-osmotic process of synthesis of Adenosine Tri-Phosphate (ATP).

There are growth factors that stimulate the activity of some methanogens: fatty acids, vitamins as well as complex mixtures such as yeast extract or peptone trypticase.

To conclude, while the macro-model that simulates a biodigestion process is properly mastered nowadays, to the point that one could summarily predict the magnitude and form of the methane productions and of the composition of a digestate, the processes are still difficult to implement. Indeed, should one wish to treat a given organic effluent, the fermentable fraction of household wastes and the same or some industrial organic wastes or wastes derived from agricultural sectors, or else a mixture of inputs (co-digestion) one should each time dedicate the process to achieve the best productivity because one optimum microbiological ecosystem corresponds to each substrate and the biochemical yield windows are narrow. In other words, the challenge is to design and implement a methane digester with low investment and low operating costs but perfectly versatile in terms of bacterial resources to ensure high methane productivity regardless of the variation in the constraints of the inputs.

A bioreactor under anaerobic condition is an artifact that tries to optimize the living conditions of a colony of given micro-organisms at a given time and/or in a given place in order to concentrate in a minimum biological retention time, therefore in a minimum bioreactor volume, the maximum production of methane which results from the digestion of the substrates placed in aqueous solution or more generally in the absence of gaseous oxygen. A biodigester consists of four major components: a sealed and often heat-insulated chamber, a stirring or intermixing device, a digestate heating device, and inlet/outlet devices for the substrate, the digestate and the biogas.

Depending on the implemented processes, one could distinguish two major types of ecosystems in such a reactor: fixed biomass and free biomass.

In a fixed biomass digester, the chamber serves not only to contain the substrate and isolate it from the air, but also to fix anaerobic bacterial colonies on suitable supports. Some liquid-phase techniques use self-sufficient fixing cells that are immersed in the flux. In general, the advantage of this process lies in the maintenance of the availability of the bacterial strains despite the permanent or sequential transfer of the flows of treated substrates, the desired objective being not to have to restart bacterial seeding or to avoid specializing the flora by chemical inputs. Several types of fixing processes are available, some for example granulate the substrate or part of the incoming substrate before seeding it and making it circulate within the chamber of the biodigester.

As a general rule, the operations of bio-oxidation of the organic wastes or matters must meet several criteria of efficiency and biosafety which are set by carrying out critical settings and adjustments. Thus, in a free or fixed biomass digester, active biomass reinforcement processes are used which result from heating and circulation of the juices and possibly from the addition of trace elements and pH correctors. The process is adaptive and relies on the spontaneous ability of the bacterial flora to specialize according to the constraints of the environment, in particular with regards to the presence of nutrients in large amounts. The adaptability of the biomass, left free to leave the chamber with the sequential or continuous flow of the streams, and to evolve according to the constraints of the ecosystem is reinforced by “external” thermal (maintenance in mesophilic conditions at 38° C. or thermophilic conditions at 55° C.), chemical (neutralization of acid or alkaline pH) and mechanical (transfers, fluidification and intermixing) actions. As a general rule, a biodigester therefore requires either good monitoring of the indications provided by sensors, in order to enable a human adjustment response in deferred time, or the automatic analysis and processing of the signals transmitted by sensors inferring in real-time the actuation of effectors.

Beyond the differentiation between fixed biomass and free population, manual or automated settings, one could distinguish two types of flow dynamics: the process can be a sequential feed process (“batch” process) or a continuous feed process.

Sequential feed processes have the major characteristic that they seek to establish, in the same chamber for a single dose of substrate, the succession of the major phases of the methane digestion. In other words, it is possible to consider that in this context the bacterial populations evolve over an identical substrate from the beginning to the end of the cycle and therefore do not need to expend energy to adapt to unexpected changes in their ecosystem, they transform it and not the other way around. Thus, as soon as loading of the tank is completed, and it can be done in one day or in three or four days, the optimum conditions for starting the hydrolysis phase are brought in (temperature, pH, nutrients, sowing). Afterwards, it is the turn of the transitory phase of acidogenesis which is regulated to enable triggering of the acetogenesis and finally of the methanogenesis. In theory, this process has the interest of having a Hydraulic Retention Time (HRT) shorter than that of continuous flow protocols and of being easier to control. In general, it is necessary to have several tanks operating in parallel which are activated one after another as they are filled. In the event of dysfunction of one cell, the treatment can be continued with the others. It is also a process where the tanks are smaller and which generally accept substrates that are denser in dry matter. Nevertheless, the sequential feed makes it necessary to multiply the chambers and the auxiliary devices such as the loading hoppers, the valves and other pumps. Moreover, the spontaneous evolution of the anaerobic microbiomes in correlation with the succession of the phases of the digestion is not guaranteed and often requires external interventions to counter inhibitions, regulate the demands for nutrients and the acid-base dynamics.

In any case, the continuous supply is strictly opposed to sequential loading in many ways. Firstly, because in the first case the ecosystem and particularly the bacterial flora are brought to be versatile, or to make coexist in the same chamber and at the same time but not necessarily in the same area of the bioreaction volume the bacteria and their co-enzymes for the four phases of the cycle. Furthermore, since, to obtain a sufficient HRT, it is necessary to size the tank on very large volumes which leads to proportional energy expenditures to maintain a suitable temperature and especially to intermix the mixture continuously in order to avoid the formation of a crust at the surface, an accumulation of excessively dense sediments at the bottom of the tank and to ensure a minimum circulation inside the bioreactors so that the transit of the substrates covers the whole variety of bacterial biomes.

Nevertheless, it should be noted that this process, which is very old since domestic biodigesters or Chinese farmers are mainly fed continuously, is well suited to micro-deposits of homogeneous organic substrates with very low variability. Indeed, with very small dimensions (a few tens of m³), wastes of stable quality and amount, they are easy to maintain if one does not seek to evacuate the sediments in real-time but rather the liquid or turbid (eluates) phase flows which can be recovered afterwards by spreading. The fact remains that after several operating cycles, these small units must be stopped and drained of their sediments which, by accumulating, reduce the useful volume of the plant and harm the development of the bacterial flora. Only some industrial processes manage to produce, in addition to biogas, highly loaded flows from which digestates are extracted by decantation and/or spin-drying, which are generally difficult to recover as a biological fertilizer. Hence, the advantage of this process, at the industrial or domestic level, lies essentially in its ability to accept a continuous flow of wastes or effluents with a low organic load with average biogas production but a possible recovery of the extracted effluents and more hardly of the “solid” fraction of the digestates.

Based on what has just been described, two major types of processes continue to compete, namely single-phase processes and differentiated-phase processes.

In the first case, whether the biodigester is of the sequential or continuous type, with fixed or free biomass, all phases take place in the same chamber. This subsystem is either gravitational (sedimentation) or counterflow and forms a large majority. The fundamental technological variations concern the modalities of the sequential or linear mixing of the substrates (intermixed vs pulsed vs infinitely mixed), the modalities of feeding the substrates and extracting the digestates and eluates.

In the second case and in theory, each of the four phases can be confined in a distinct tank and the passage of the modified substrate upon completion of each phase into the next one is ensured by a mechanical or hydraulic system. Actually, the prior art obviously favors two-phase systems in which the hydrolysis and the acidogenesis are confined in a first chamber while the acetogenesis and the methanogenesis are ensured together in the second chamber. The goal pursued by these multiphase processes is to better manage the phases individually by acting on the micro conditions optimizing these different ecosystems.

More complex and expensive, the differentiated-phase processes nevertheless have a better yield in terms of biodegradability, in particular for substrates which require a strong enzymatic speciation and/or a particular chemical or thermal environment. On the other hand, for a flow of wastes that are homogeneous over time and whose composition offers no particular risks (especially at the acetogenesis stage), it is generally considered that this process does not provide enough added value to legitimize the required complexity and investment.

Finally, a distinction is made between three types of biodigesters according to the concentration of Total Suspended Solids (TSS) in the flows, i.e. the proportion of Dry Matter (DM) dissolved in the digester. Thus, one could distinguish low DM concentration biodigesters with less than 10% TSS, medium DM concentration biodigesters, containing between 15% and 20% TSS, and high DM concentration biodigesters, containing between 22% and 40% TSS; all these indications are given in weight percent.

Flow biodigesters with a low TSS content have as main inputs industrial or domestic effluents, as is the case for wastewater treatment plants or highly volatile solid inputs rich in highly diluted inhibiting components (VFA, NH₄⁺). These biodigesters have a particular configuration; the principle consists in using the biodigester as a sedimentation tank where the TSS are retained and treated anaerobically while a flow of more or less purified water escapes. Thus, the Biological Retention Time (BRT) of the TSS is longer there than that of the total flow (HRT) because the biodigester integrates a passive or active decantation system and a system for retention/anaerobic degradation of the sedimented digestible DM.

As such, these biodigesters are unsuitable for the treatment of solid organic wastes except that these are shredded and put into solution with effluents which will always form most of the input or which are highly diluted. Under these protocols, the production of biogas and digestates (in this case in the form of sludge) is relatively low, but above all their ability of primary purification of an effluent is looked for, and their energy balance is balanced with the cogeneration of the biogas. Possibly, the productivity of these subsystems improves with the resale of digestate liquors (eluates) as liquid organic fertilizers when they can, on the one hand, demonstrate a proven biological stability and be transported over extended areas in order to guarantee a low concentration when spreading, which is always difficult to ensure under normal operating conditions, unless significant logistical costs to widen the spreading area enough are accepted. With this type of process, the applicable maximum volume loads are in the range of 2 to 5 kg of COD/m3/d.

The family of biodigesters with an average TSS concentration is the most common. In this configuration, a solid digestible substrate is dissolved in two to three times its weight in water. This modality of dissolved organic matter density corresponds to a search for balance between the amount of digestible matter, its viscosity and its coalescence in the chamber of the digester and the capacity of the anaerobic environment to accommodate and maintain bacterial populations without risking inhibition thereof by biochemical saturation. Indeed, for the bacterial activity to operate under the best conditions, the digestate must not compact as long as it can be mobilized as the different phases of biodigestion progress. Hence, this process is suitable for the treatment of the digestible fraction of the solid organic wastes subject to an effective sorting upstream to evacuate the undesirable components and a relatively fine shredding which authorizes the hydraulic transfer of the digestible mass and the proliferation of high bacterial diversity.

More suitable for continuous rather than sequential feed processes, medium DM concentration biodigesters particularly profit from fixed biomass systems because the substrate flow has a flow rate that is high enough to deplete the resident flora. In general, the volume loads to be applied can reach 15 to 20 kg COD/m3/d. The hydraulic stay times vary between 4 and 5 weeks. Under this configuration, the biogas yields are good and the production of digestates in the form of a more or less fibrous substrate requires at least a decantation if not a centrifugation.

Some organic waste deposits consist of a large solid fraction with low digestibility: the mass of DM is high but the proportion of Volatile Organic Matter (VOM) to the DM is low. To the extent that it is not possible to validly concentrate the VOM of these wastes, it is desirable to have a technology that authorizes treatment thereof anaerobically. Some biodigesters are designed for this type of application; they are said to have a high concentration in DM.

The specificity of these biodigesters lies in the mode of progress and intermixing of the substrate and in the fact that they almost exclusively consist of free biomass sequential feed bioreactors, but with seeding. In general, it should be noted that beyond a given threshold of VOM content, there is a risk of overload which could lead to inhibition of methanogenesis, which is especially valid for wastes rich in animal proteins (carcasses and fat) or ammonium (litter and slurry). In addition, the volume loads to be applied can reach 40 kg COD/m3/d. The hydraulic stay times vary between 2 and 3 weeks.

Thus, it is necessary to take into account the fact that beyond 3 g/l, ammonium (NH₄⁺) is an inhibitor of methanogenesis. It is also known that this limit of 3 g/l of NH₄⁺ should not be exceeded for wastes whose C/N ratio is equal to or lower than 20 with a VOM level in the range of 60% of the OM.

Beyond and complementarily with dilution with water, the most common technique for keeping these particular organic substrates below the inhibition threshold consists in mixing the wastes that are too rich in protein (viscera, fish, dairy products, carcasses and other meat wastes) with carbonaceous substrates.

The alternative to the mixture control approach consists in lowering the MOV content of the wastes (especially the proportion of ammonium) by subjecting it to a prior phase of intense thermophilic aerobic fermentation, but this requires in any case that the meat wastes are mixed with carbonaceous substrates.

Another alternative consists of a heat treatment at low temperature inducing thermolysis which particularly affects the VFAs and restitutes them in an increased digestibility configuration. These three techniques can be mobilized together, the heat treatment occurring sequentially at first.

To conclude, regardless of the retained methane digestion process, four parameters strongly contribute to ensuring satisfactory biological productivity and proven economic feasibility:

Firstly, the non-destructive positive displacement deep intermixing of the structured biomes established by the bacterial colonies within the digestates undergoing anaerobic maturation in presence and their enzymatic commensals. This intermixing is particularly necessary in the compacting sedimentation area where it must promote active bioturbation dynamics.

Secondly, the treatment of the digestates to make them recoverable as biofertilizer, without any environmental or biological risk. This is generally completed after liquid/solid phase separation or more rarely by thermophilic aerobic maturation.

Thirdly, the availability of digestible organic carbon in a progressively mobilizable form and in proportion to the particular demand of each methane digestion phase in order to always remain below the VFA and ammonium inhibition threshold.

Fourthly, the thermal management of the bioreactors to reach and maintain an optimum temperature which requires energy inputs that are all the more significant as the volume of the tanks is large, or in other words, all the more so as the dilution within the bioreactors is considerable.

The present invention is intended to provide an integrated solution to the difficulties encountered by the different existing methane digestion processes confronted with the risks of inhibition by lack of digestible carbon or by lack of dilution water, the impossibility of rejecting into the environment raw digestates and the energy expenditures required due to the thermal needs of the bioreactors.

### SUMMARY

The present invention relates to infinitely mixed continuous as well as sequential feed multi-phase anaerobic digestion processes, regardless of their content in volatile organic solids, whether these are free or fixed biomass, mesophilic or thermophilic.

Preferably, the invention relates to continuous feed multi-phase processes, mesophilic and thermophilic, and with a high content in volatile solids and fixed biomass.

According to an essential aspect of the invention, methane digestion equipment is coupled with composting equipment in a closed vessel, which allows carrying out the addition of raw compost and the injection of composting percolates into the digester, ensuring the treatment of the digestates by co-composting with ligneous matters to produce a stable and balanced biofertilizer. This also, and advantageously, allows capturing heat in the composting silo to transfer it into the tanks of the bio-digester.

Thus, a first object of the invention is a continuous process for treating organic wastes taking place in a coupled plant, said process for treating organic wastes including a process for anaerobic digestion of a first part of said wastes, which takes place in at least one digestion chamber, and a process for aerobic composting of a second part of said wastes which takes place in at least one composting chamber, in which process for treating organic waste:
upon completion of said anaerobic digestion process, digestate and biogas are collected,
upon completion of said aerobic composting process, compost and humic percolates are collected,
at least part of said digestate is fed into said aerobic composting process, and
at least part of said humic percolate is fed into said anaerobic digestion process.

Typically, said first part of said organic wastes includes essentially volatile organic wastes, selected from the group formed by: slaughterhouse wastes, dairy wastes, winemaking wastes, fish processing wastes, meat processing wastes, stable livestock wastes, kitchen and table wastes, organic wastes originating from the agri-food industries.

Typically, said second part of said organic wastes mainly includes structuring organic wastes, which are mainly organic polymers of the lignin, cellulose, hemicellulose and/or keratin type, and/or said second part of said organic wastes mainly includes wastes selected from the group formed by: sawing wastes (such as sawdust or wood wastes from sawmills), shredded forest wastes, shredded wood wastes or products, brown cardboard, shredded plants of various origins such as pruning, clearing, collection of dead leaves, various agricultural wastes such as straw.

In a preferred embodiment, said aerobic composting process takes place in at least one composting chamber, preferably vertical to ensure enough height for the percolation process, and provided with a first heat exchanger by which said composting chamber heats a heat-transfer fluid to a first temperature, and/or said aerobic digestion process takes place in at least one digestion chamber provided with a second heat exchanger by which said at least one digestion chamber is heated by said heat-transfer liquid at a second temperature, lower than said first temperature.

Quite advantageously, said first part of said organic wastes is subjected to a thermal pretreatment in a thermal pretreatment chamber, at a temperature higher than 45° C., and preferably comprised between 70° C. and 80° C., before being cooled and input into said anaerobic digestion chamber.

Advantageously, said thermal pretreatment chamber is provided with a third heat exchanger.

In an advantageous embodiment, at least part of said heat-transfer fluid heated by said first heat exchanger is conveyed into said second heat exchanger.

The biogas generated by the anaerobic digestion process or the biomethane is extracted therefrom by filtering. It can supply fuel to a burner provided with a fourth heat exchanger which heats a heat-transfer liquid, which is in thermal communication with said second heat exchanger and/or said third heat exchanger.

In a particular embodiment, said burner is in energy communication with an electrical energy generator, which preferably supplies electrical energy to at least one portion of said plant.

Another object of the present invention is a plant configured to execute the process according to the invention. This plant comprises:
an anaerobic digestion unit for the treatment of said first part of the organic wastes, including successively a first chamber intended for carrying out the hydrolysis and the acidogenesis, a second chamber intended for carrying out the acetogenesis, a third chamber intended for carrying out the methanogenesis, and a fourth chamber intended for degassing, said four chambers being successively in fluidic connection (preferably by assisted overflow) to enable the transfer of treated wastes from one chamber to the next one, said anaerobic digestion unit being configured to produce essentially digestate and biogas;
   a composting chamber intended for carrying out the aerobic composting of said second part of the organic wastes, configured to produce essentially compost and humic percolates;
   means for transferring said digestate from said degassing chamber to said aerobic composting unit;
   means for transferring said compost and said percolate to said anaerobic digestion unit.

Quite advantageously, the plant includes a thermal pretreatment chamber disposed upstream of said anaerobic digestion unit so that said first part of the organic wastes intended to enter said anaerobic digestion unit passes through said thermal pretreatment chamber.

In an advantageous embodiment, the plant is configured so that:
at least one of said chambers of said anaerobic digestion unit is heated using a heat-transfer liquid;
said thermal pretreatment chamber is heated using a heat-transfer liquid;
said aerobic composting chamber is cooled by a heat-transfer liquid; and
the heat recovered on said aerobic composting chamber is used to heat at least one of said chambers of said anaerobic digestion unit and/or said thermal pretreatment chamber is heated using a heat-transfer liquid.

At least part of the heat transmitted by the aerobic composting chamber to the heat-transfer liquid which cools it down can be used to heat at least one of the anaerobic digestion units.

Advantageously, the plant comprises a burner configured to burn the energy fraction of the biogas (which mainly includes methane) produced by said anaerobic digestion chamber. This thermal energy can be used in two different ways, which can be combined within the plant: on the one hand, said burner can be configured to heat a heat-transfer fluid which is in thermal communication with at least one of said chambers of said anaerobic digestion unit and/or with said thermal pretreatment chamber. On the other hand, said burner can be associated with an electrical energy generating device. The plant can be configured so that said electrical energy generating device could supply said plant with electrical energy, for part or all of its needs, knowing that the plant comprises accessory means, such as pumps, conveyors, solenoid valves, which use electrical energy.

Thus, the invention allows making an organic waste treatment plant, associating the anaerobic digestion with the aerobic composting, and involving composting of the digestates and recycling of the humic percolates in the anaerobic digestion, which can cover at least part of its own electrical and/or thermal energy needs.

### DRAWINGS

FIG. 1 shows a diagram of an advantageous embodiment of the process according to the invention.

FIG. 2 shows a first detail of the diagram according to FIG. 1.

FIG. 3 shows a second detail of the diagram according to FIG. 1.

FIG. 4 is a simplified schematic representation of a device that can be used to implement the process according to the invention.

The three-digit reference numerals refer to elements of the device, while the four-digit reference numerals refer to steps or aspects of the process.

### DESCRIPTION

In general, the process according to the invention allows using organic wastes from very diverse origins. In particular, this may consist of slaughterhouse wastes, kitchen and table wastes, plants or ligneous products of agricultural, forestry or industrial origin. In general, the process according to the invention allows using liquid wastes such as blood or scrap from the dairy or wine industry, and solid wastes such as viscera, spent grains, marc or the fermentable fraction, household wastes and the same.

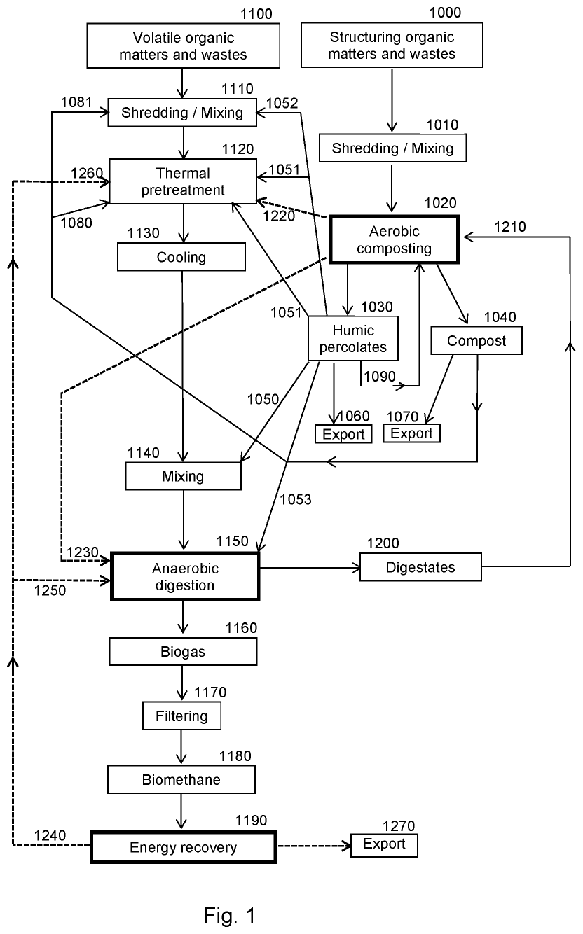

The process according to the invention will be described herein in detail first with reference to FIG. 1.

The process according to the invention mobilizes two different raw materials, which are both organic matters or wastes. The first raw material consists of so-called structuring organic matters or wastes (essentially organic polymers of the lignin, cellulose, hemicellulose, keratin type). The second raw material consists of volatile organic matters and wastes (essentially organic molecules such as sugars, proteins, carbohydrates, therefore weakly polymerized).

These raw materials and their biological transformations will be explained with reference to FIG. 1 which schematically shows an embodiment of the invention. In this figure, the solid lines represent a matter flow, the dotted lines an energy flow. The thick boxes represent a reactor, the other boxes represent a product or a process step.

The process according to the invention uses as raw material organic wastes supplied in the form of structuring organic materials and wastes 1000. These consist of mainly solid, highly polymerized wastes, which are difficult to degrade by anaerobic biological means; as such, they may comprise ligneous matter or other cellulosic matters and/or keratin. In particular, these may consist of sawing wastes, sawdust, shredded plants of various origins (pruning, clearing, collection of dead leaves or straw), shredded forest wastes, shredded wood products, cardboard (in particular brown cardboard). These wastes are supplied in a divided form, for example in the form of granulates or shreds not exceeding a typical dimension of about 50 mm×20 mm (and preferably not exceeding a dimension of about 30 mm×20 mm). They may be dry or wet.

These solid organic wastes can undergo a new shredding which allows reducing them to a finer particle size 1010. This shredding can be carried out for example in a device such as a slow two-axis knife mill, supplied with matter by a loading hopper. Afterwards, they are transferred, typically via a hopper, into a composting chamber 1020 which acts as a bioreactor. As this will be described hereinbelow, according to an essential feature of the process according to the invention, these structuring wastes will be mixed for composting thereof with another fraction resulting from the process according to the invention, namely the digestate derived from the anaerobic digestion of the volatile organic wastes.

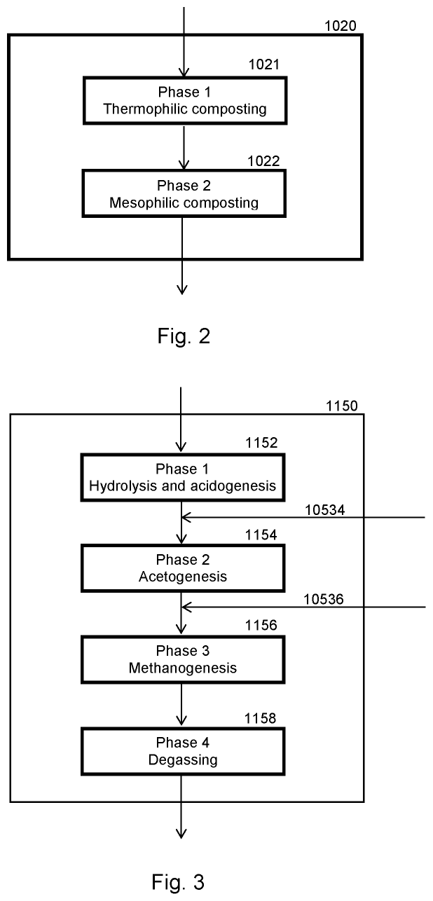

The composting process is an aerobic process that takes place in two distinct phases; for this reason, said composting chamber, which is typically made in the form of a vertical silo, has two compartments, each of which is dedicated to one of the two phases of the composting process. These two phases are represented in FIG. 2.

The first phase 1022 of the composting process 1020 is an aerobic, thermophilic and exothermic process which takes place at a temperature in the range of 65° C. to 75° or 80° C. under the combined effect of various micro-organisms. The treated matter must be supplied with moistening water (which typically comprises, or which consists of, recirculated humic percolate) and fresh air. The second phase 1024 of the composting process 1020 is mesophilic. Composting generates two fractions, namely a liquid fraction, called humic percolate 1030 and a solid product called compost 1040. As indicated hereinabove, it is necessary to maintain a circulation of the humic percolate 1090 in the aerobic composting chamber.

Each of these two by-products can be recovered outside the process according to the invention according to processes known as such; this output of the process is herein called “export”. For example, the compost can be exported 1070 to be used to improve an agricultural or horticultural culture medium, rich in humic matter and minerals. The humic percolate is rich in humic acids and co-enzymes. Its dry matter content is low, preferably lower than 5% by weight, typically lower than 4%. It can also be exported 1060 to be used as a biostimulant of soil life and plant growth.

It should be noted that the solubilization of the humic acids in the percolate requires a long stay time in a permanent thermophilic area (temperature typically comprised between 65° C. and 80° C.) which forms in a composting chamber with a sufficient size (and in particular with a sufficient height); this chamber must have a sufficient level of maturity. These conditions typically require that the thickness (height) of the windrow in the chamber be at least 3 meters, and preferably at least 3.5 meters, and even more preferably at least 4 meters. Moreover, it is advantageous to permanently recirculate the effluents in the composter (step 1090 in FIG. 1) so that these progressively become loaded with humic acids. Thus, a humic percolate is formed, which typically has a coffee color, and which substantially differs from the simple effluents of a known type of composting reactor.

The process according to the invention also uses volatile organic matters and wastes as raw material. The term “volatile” herein refers not to a gaseous nature but to their easier biochemical decomposition: These matters and wastes are weakly polymerized. They can be liquid, muddy or solid; they can comprise for example proteins, lipids, carbohydrates or sugars. In particular, these may consist of slaughterhouse, dairy, winemaking, fish and meat processing, stable livestock, kitchen and table wastes, and more generally organic wastes originating from the agri-food industries. They typically comprise solid fractions and liquid fractions; their liquid fraction may include water and various liquid organic wastes, such as blood, oils, various juices.

These volatile organic materials and wastes (numeral 1100), as a whole or at least their solid fraction, can first undergo a shredding which allows reducing them to an acceptable particle size (numeral 1110). Afterwards, they are subjected to a thermal pretreatment 1120 which will be explained hereinbelow.

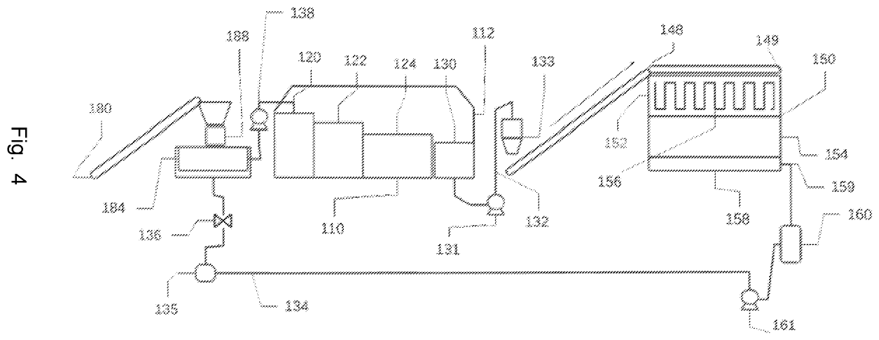

According to the invention, upon completion of their heat treatment, these volatile organic matters and wastes are subjected to an anaerobic digestion process (numeral 1150), also called methane digestion because it produces methane. The anaerobic digestion 1150 is an endothermic process that takes place in several phases, which are represented in greater detail in FIG. 3. It takes place by successive passage of the mass in several chambers hydraulically connected in series.

In a first step 1152 executed in a first heated chamber, two anaerobic microbiological processes are carried out which take place at the same time, using two different microbial strains which can coexist within the same mass, namely hydrolysis and acidogenesis. Typically, these two processes take place at a temperature in the range of 38° C. to 40° C., with a stay time comprised between three and ten days. In a second step 1154, the mass is transferred (preferably by assisted overflow) into a second heated chamber and it is subjected to an acetogenesis process; the stay time is in the range of eight to twelve days. In a third step 1156, the mass is transferred into a third heated chamber and it is subjected to a methanogenesis process; the stay time is in the range of twelve to eighteen days. In a fourth step 1158, the mass is transferred into a fourth degassing chamber to collect the small fraction of biogas that has remained fixed in the digestates by surface tension (numeral 1160). The biogas produced during the anaerobic digestion 1150, rich in methane, is trapped in the headspace that covers the three tanks of the digester in a single flexible and sealed envelope.

According to an essential feature of the invention, the process couples the aerobic composting 1020 to the anaerobic digestion 1150 by executing reciprocal exchanges of solid and liquid matters from one of these two bioreactors to the other one.

Thus, the chambers in which the different digestion phases 1152, 1154, 1156 take place may be supplied with humic percolate (numeral 1053) originating from the composting chamber. More specifically, the humic percolate 1030 is preferably added into one of the chambers (or into both of them at the same time) in which the acetogenesis 1154 and the methanogenesis 1156 take place, these additions being identified in FIG. 3 by the numerals 10534 and 10536, respectively, and/or upstream of the anaerobic digestion 1150, namely into the thermal pretreatment chamber (numeral 1051) and/or, possibly, into the mill 1110 located upstream of the thermal pretreatment chamber (numeral 1052), and/or possibly, into an optional mixer 1140, which is located between the thermal pretreatment chamber 1120 and the anaerobic digestion 1150. In a preferred embodiment, the humic percolate 1030 is fed into the thermal pretreatment chamber 1120.

Subject to the presence of sensors measuring the Redox potential (Eh) in each of the three tanks of the methane digestion cycle, it is possible to inject humic percolates individually and automatically into each tank to induce a fine regulation of the optimum chemical bio-reactivity that is specific thereto.

Moreover, it is possible to supply the anaerobic digestion process 1150 with compost 1040 originating from the composting chamber. Preferably, this compost 1040 is added during the homogenization step 1120, namely in the thermal pretreatment chamber 1120 (this addition route bears the numeral 1051) and/or in the mill 1110 located upstream of the thermal pretreatment chamber (this addition route bears the numeral 1081).

As indicated hereinabove, the proper progress of the anaerobic digestion process 1150 requires the presence of a sufficient amount of digestible organic carbon (which typically amounts to about half the organic dry matter for a given organic waste) to avoid inhibition of the process. It is the addition of percolate 1050, 1051, 1052, 1053 to the matters and wastes 1100 entering the composting chamber that allows controlling the correct content of digestible carbon in the digestion chambers 1150.

As indicated hereinabove, the anaerobic digestion process according to the invention can use volatile organic matters and wastes (numeral 1100), which are typically present in a fluid form, i.e. liquid or muddy or loaded with shredded solid particles. These may be wastes of various origins, shredded and/or homogenized. Advantageously, these wastes are rich in proteins, lipids and sugars. Sludge from biological treatment plants can also be used, but on condition that these do not include chemical substances likely to interfere with the final use of the exported compost 1260 and percolate 1240.

Depending on their origin, it might be necessary to thermally pretreat said volatile organic matters and wastes 1110 in a heat treatment chamber (numeral 1110). For example, the wastes of food products collected after placement thereof on the market (kitchen wastes originating from households or from catering) or originating from the agri-food industry, as well as more specifically the animal by-products and the products derived therefrom must undergo an appropriate heat treatment (hygienization, pasteurization, and even sterilization in case of a high sanitary risk) for recovery and elimination thereof in biological processes. As described hereinabove, compost and humic percolate originating from the composting chamber are added to the mass intended for anaerobic digestion. According to a very advantageous embodiment, the added compost is also subjected to the heat treatment 1120, and for this reason it is added either at the shredding/mixing stage 1110 or directly in the heat treatment chamber 1120. Indeed, the heat treatment of the compost eliminates some strains likely to interfere with the anaerobic digestion process. The percolate can also be subjected to the heat treatment, together with the mass to which it has been added.

The anaerobic digestion 1150 generates biogas (numeral 1160). The biogas is rich in methane; it also includes nitrogen, water and carbon dioxide. It is subjected to a filtering process 1170 to separate the methane. The latter can undergo an energy recovery 1190, in a burner, and/or it may be exported.

The anaerobic digestion generates a muddy or pasty residue called digestate (numeral 1200) which is mixed with shredded structuring wastes and this mixture is transferred into the composting chamber (numeral 1210) to be decomposed into compost 1040 and humic percolates 1030, as described hereinabove.

According to a very advantageous implementation of the process according to the invention, the anaerobic digestion chambers 1150 and the aerobic composting chamber 1020 are connected not only by matter flows, but also by energy flows. Indeed, the overall process includes at least one exothermic step, namely the first thermophilic phase 1022 of the aerobic composting 1020 (and, where appropriate, also the energy recovery 1190 of the biogas), and at least one endothermic step, namely the anaerobic digestion 1150 (and, where appropriate, also the thermal pretreatment 1120 of the fluid wastes). These energy flows are represented in FIG. 1 by dotted lines. The thermal energy released during cooling 1130 of the fluid organic matters and wastes after heat treatment 1120 thereof can also be recovered.

Thus, in a very advantageous embodiment of the plant according to the invention, the aerobic composting chamber 1020, and more specifically its compartment dedicated to the thermophilic reaction 1022, includes a heat exchanger capable of absorbing the reaction heat produced during the thermophilic composting phase, and transferring it, by means of an appropriate heat-transfer fluid which may be water, to a heat exchanger associated with the aerobic digestion chamber 1150, capable of heating the mass contained in this chamber. Alternatively, said heat-transfer fluid heated by the aerobic composting chamber 1020 can also heat the thermal pretreatment chamber 1120.

According to another advantageous aspect of the plant according to the invention which can be combined with the previous one, the burner that ensures the energy recovery 1190 of the biomethane, heats a heat-transfer fluid (numeral 1240), typically water (for example in the form of superheated steam) which supplies the heat exchanger of the anaerobic digestion chamber (numeral 1250) and/or the thermal pretreatment chamber (numeral 1260). The rest of the energy originating from the energy recovery of the biomethane can be exported (numeral 1270); it may be thermal or electrical energy, the latter being generated either by gensets with cogeneration or by a turbine driven by a gas heated by the combustion of the biomethane. At least part of said electrical energy can be used by the plant itself, which includes matter flow transfer means (such as pumps for fluid organic wastes 1100, the wet percolates 1030 and the digestates 1180, and conveyors for the compost 1040) which consume electrical energy. These energy flows are not represented in FIG. 1 so as not to overload it.

Thus, the invention allows making a plant which is completely energy self-sufficient, and which is also capable of producing a very significant surplus of energy.

A major advantage of the process according to the invention lies in the fact that it is carried out continuously, in contrast with discontinuous processes (“batch” mode), the flows of matter take place almost continuously, the chambers do not need to be drained and restarted periodically.

The process according to the invention allows recovering the digestate derived from an anaerobic digestion process. In the known processes, the digestate still includes volatile matter which is not mineralized, which poses a problem when spreading the digestate over agricultural land surfaces. The process according to the invention recovers these volatile matters in a composting process. The input of digestate with dry matter equivalent mass with structuring wastes allows not only improving the dynamics of the thermophilic phase of composting but also increasing the level of nitrogenous nutrients in the compost very substantially.

Finally, the process according to the invention feeds the percolate derived from this composting process very partially again into the anaerobic digestion process. Thus, the volatile material is best used in a cyclic process.

Referring to FIG. 4, we now describe a plant according to the invention which allows implementing the process according to the invention which has just been described.

The plant according to the invention comprises an anaerobic digestion unit 110. It comprises four chambers receiving liquid phases, and one chamber receiving the generated biogas, as this will be explained now. The first chamber 120 is a heated chamber in which the hydrolysis and the acidogenesis take place at the same time 1152. The second chamber 122 is a heated chamber in which the acetogenesis takes place 1154. The third chamber is a heated chamber 124 in which the methanogenesis takes place 1156. The fourth chamber 130 is a degassing chamber 1158 in which the biogas is separated from the digestate (degassing phase 1158).

Said first 120, second 112 and third 124 chambers are heated by a heat-transfer liquid. The successive transfer of the liquid phase from one tank to another can be done by assisted overflow of the contents of one chamber into the next chamber, as symbolized in the figure by the difference in height of the chambers. The biogas accumulates in the fifth chamber 112 which is closed by a flexible roof which is extensible according to the pressure of the biogas.

The anaerobic digestion unit is loaded by a loading means 180 which may be a belt conveyor or, preferably, a pneumatic conveyor. The raw material enters a hopper then a mixer 188, before being input into the thermal pretreatment chamber 184. The latter is typically a water bath, with a heat-transfer fluid which is typically water. A pump 138 conveys these pretreated wastes to the anaerobic digestion unit 180. The digestate is evacuated by a pump 131 to a mixing tank 133.

Moreover, the plant includes a chamber 150 for aerobic composting. The chamber may be a cylindrical or parallelepiped and vertical silo, with a bottom, a lid and an envelope made of sheet metal, preferably stainless steel, or coated on the inside with a plastic film, which is preferably made of polypropylene. The chamber has in its upper portion means 148, 149 for inputting the volatile organic matters and wastes and liquid digestate. This chamber comprises a first area 152 in which the thermophilic phase 1021 takes place, and a second area 154 in which the mesophilic phase 1022 takes place. In one embodiment, said first area 152 is located in the upper portion of the chamber 150 and the second area 154 in the lower portion of the chamber 150.

At least over the portion corresponding to the first area 152, the wall of the chamber is surrounded by a heat exchanger, typically a serpentine 156, connected to a circuit in which circulates a heat-transfer fluid, which is typically water. At the bottom of the chamber, there are means 158, 159 for discharging the humic percolates and the compost into an intermediate reservoir 160. The transfer to the anaerobic digestion unit 110 will be described in more detail hereinbelow.

A more detailed description of some important aspects of the invention is given herein, so that a person skilled in the art could implement the objects of the invention.

### 1. The Addition of Raw Compost and Composting Percolates to the Anaerobic Digester

The collection of raw compost and raw composting percolates is carried out during the co-composting of the digestates derived from a complete cycle of the methane digester within a composting silo, according to processes known as such, for example as described in WIPO Patent Publication No. WO 2017/109398. The raw composts are particularly rich in digestible carbon and in simple, non-saturating nitrogen compounds, compatible with the nutrient demand of anaerobic bacteria. The percolates rich in humic acids, tannins, carbonaceous colloids result from the liquid/solid phase separation of the digestates mixed with shredded ligneous or cellulosic materials (the composting substrate) subjected to intense and thermophilic then mesophilic reactions of bacterial bio-oxidation. Although containing only very little dry matter, typically in the range of 2% to 4% by weight, it is known that these percolates include biochemical mediators and co-enzymes capable of intensifying the anaerobic bacterial activity by promoting in particular cell growth.

One should emphasize the stable quality over time of the composts and of the humic percolates that are produced in just-in-time flows at the same rate as that of the upstream biodigestion process. Hence, the additions of the composting products into the digester tanks are regular with dosages that are easy to perform.

According to the invention, the doses of compost and raw percolates are injected in three modes. They are first injected at the start of the methane digestion process to replace other carbonaceous inputs and dilution water. It is also advantageous to integrate them into the feed dose of the digester subjected to a thermal pretreatment if such a thermal treatment is practiced. Finally, it is possible and profitable to inject them in an appropriate manner into each of the three digester tanks according to data provided by biochemical index sensors (Eh, pH, biogas production and biogas composition, total alkalinity, total carbon) ; indeed, throughout the anaerobic digestion process on the basis of biochemical indices the injection of compost and raw percolates has a particularly high impact in multiphase processes because the injection of these carbonaceous and humic compounds is performed in a much more targeted manner.

The additions obtained in this manner of digestible carbonaceous organic matter and of bacterial metabolism intensifiers in aqueous dilution not only allow optimizing the biochemistry of the process but also form one of the vectors of a circular economy which has the great advantage at the end of cycle of producing digestates transformed into compost highly recoverable as biofertilizers, with none of the drawbacks of spreading raw digestates, the negative impact of which on the environment is known.

Another positive consequence of this process is that the partial recycling of the liquid phase of the percolated digestates throughout the composting silo saves all of the needs for dilution water necessary for a non-inhibiting dosage of the volatile fraction that feeds the digester while leaving these particularly effective humic liquors available for agronomic use after aerobic bubbling to regenerate soils and support their biotic activity.

### 2. Creation and Maintenance of a Bioturbation Area in a Digester Tank

Its main objective is the intensification of biogenic and biochemical exchanges in the most turbid horizon which tends towards a coalescent and solid sedimentation. Non-destructive positive displacement intermixing, associated with a bubbling cycle by recirculation of desulfurized biogas possibly hydrogen-enriched, prevents the solidification of the tank bottom sediments and enables the intensification of the exchanges. Indeed, the movements of sediments do not take place to the detriment of the accretive structures built by assembling the exopolymers of biofilms resulting from bacterial activity on fixing bases or nodules. In the process according to the invention, the fixing nodules may be exogenous, i.e. fed as artefacts into the tanks to promote fixing of biomass, or even more favorably endogenous, i.e. generated progressively with the anaerobic digestion due to the degradation of organic matters such as flesh still attached to bony structures or bones, digestible plant teguments supported by a ligneous skeleton, nails, hairs and other organic compounds rich in polymers such as keratin.

In a continuous feed process, it is necessary to prevent the excessive accumulation of endogenous fixing nodules; for this reason, this operation is preferably carried out by pumping on the critical lower horizon by regularly extracting doses that do not jeopardize the fixing functionality of this horizon.

A sedimentation of the indigestible residues rich in calcium or keratin is always observed, moreover the input of raw compost still structured in partially digestible fibers is either absolutely necessary in the case of substrate poor in endogenous fixing nodules or recommended to enrich the fixing base. In any case, the formation of a biofilm anchored on these fibrous or calcified particles which brings together in a holistic densitometric horizon a wide variety of bacterial colonies forms a complex ecosystem which not only confers resistance to (trophic or physical) disturbances of the environment but above all enables an organization in a trophic chain with very active exchange dynamics, starting from activated sediments and covering the entirety of the column of substrates in dilution.

Indeed, it should be emphasized that when the calcium nodules are maintained in the deep sedimentary horizon, the solid fibrous materials derived from the raw compost, which have a lower density, are maintained in the ascending flow within the tank in the presence of the dilution and metabolic intensification solutes, the composting percolates being close to the density of water are actually present in the entire volume of the tank while the denser mineral co-enzymes will migrate rapidly to the bottom of the tank.

To promote this bioturbation dynamic in the sedimentary horizon and in the upper layers of the flow of matters, the reactor according to the invention may comprise a system of convergent hydraulic deflectors. Advantageously, these deflectors are positioned at two determined heights in the anaerobic digestion tanks, namely at approximately the lower third and at mid-height of the tank. The deflectors may be made in the form of 3 mm thick simple rigid plastic plates, ideally of polypropylene, fastened on bars crossing the tanks laterally (these bars acting as rigidity tie rods). The plates or deflectors function as directional flaps placed opposite one another in symmetrical opposition with a distance between the upper edges of the flaps which is preferably not less than 300 mm. Advantageously, the inclination of the flaps meets an angle comprised between about 20° and about 45°, and preferably about 30° on the lower flaps, and between 40° and 60°, and preferably about 50° on the upper flaps; the angle can vary in opening or closure depending on the turbidity of the substrate in the tank as well as the gap between the upper edges of the flaps.

This system of deflectors promotes ascending flow dynamics at the center of the tanks by channeling the rise of the sediments in the form of a current while carrying particles as generated by bubbling.

### 3. Details on Some Aspects of the Device According to the Invention

Among the means mobilized to qualify the invention, coupling with a composting unit and the mixing and heating equipment by submerged flexible cisterns could be set forth. Practical embodiments of these aspects are indicated herein.

As regards coupling with a composting unit:

According to one embodiment, a digestate transfer route to the composting unit consists of a digestate degassing tank 130, a pump 131 for viscous fluid with a high total solids content, a pipe 132 with a sufficient diameter (at least DN80) provided with a purge device, a mixing tank 133 which receives the digestates on a sufficient dose of shredded structuring ligneous wastes.

According to one embodiment, a route for conveying the composting percolates consists of a raw percolates containment cistern 160 connected to a slurry pump 161, a pipe 134 connecting said pump 161 to the thermal pretreatment tank 184 where the organic matters 1080/1081; 1051/1052 entering the digester 110 are preheated 1120 (advantageously after shredding 1081/1052), a device 135 for measuring the transferred volume of percolate, and at least one valve 136 which may be a manually-operated valve or an automated solenoid valve.

A heat exchange device may consist of an isothermal wall supporting a network of water pipes and whose contact face for heat transfer will be fastened on the metal walls of a composting silo in the thermophilic area. The circulation of water with a demand at 40° C. can be regulated by thermosiphon with a gradient in the range of 25° C.

As regards the mixing and heating equipment using submerged flexible cisterns:

According to one embodiment, a device for heating water or a heat-transfer fluid consists of a water bath heating tank, a boiler powered by biomethane or biogas, a thermal or mixed PV and thermal solar station, a passive system for recovering heat on the walls of a composting silo in a thermophilic area, or the assembly of all or part of these means.

Moreover, such a device advantageously comprises a pump capable of moving hot water up to 60° C. with a setting adapted to the configuration of flexible cisterns on the following basis (without inferring pressure drops). This setting is described by two parameters:

The first parameter is the nominal flow rate of the pump Dp=(Vi−Vm)/T, expressed in m3/h; in this equation Vi is the intermediate volume of a flexible cistern, Vm is the minimum volume of a flexible cistern and T the time (expressed in hours) retained to switch from the state Vm to the state Vi.

The second parameter is the nominal operating pressure that the pump must deliver Pp=((d×Hs)/10)×1.25, expressed in bar (a 10 m water column) with a safety factor of 1.25; in this equation d is the bulk density of the digestates, and Hs the height of the column of digestates above the surface of the flexible cisterns at the stage Vm.

Moreover, such a device advantageously comprises a digital transmission flowmeter and a device for thermal regulation by thermocouple or a programmable logic controller system connected to one or more temperature sensor(s) and to a digital transmission flowmeter which controls the power supply of the pump and of the solenoid valves.

Moreover, such a device comprises hydraulic connections through sealed walls allowing connecting the flexible inlet and outlet pipes of the heat-transfer flow of the submerged flexible cisterns with the outside of the digester. It also comprises connections suited for sealed and durable fastening of the heat-transfer flow pipes on the submerged flexible cisterns.

As already mentioned, such a device comprises flexible cisterns. These enable the perfect containment of hot water at 60° C. or of a heat-transfer flow with aggressiveness parameters equivalent to or lower than hot water and resistance to chemical and mechanical attack of hot water or of a heat-transfer fluid. They must withstand a given water column pressure, which is typically a maximum of 8 meters (0.8 bar) with a minimum, intermediate or maximum filling. They must resist, at least on their external face, the chemical and mechanical attacks of the digestates.

A system for fastening said flexible cisterns at the bottom of the tank enables deployment thereof for the different filling phases and at the same time prevents intermixing of digestates between the bottom of the tank and the cistern.

Advantageously, a system for fastening the submerged flexible cisterns at the walls of the tank completes the main device for flexible cisterns submerged at the bottom of the tank.

The device according to the invention may comprise auxiliary means which facilitate use thereof or which make it more versatile.

Thus, it may comprise a system for shredding the incoming wastes and substrates allowing reducing their relative size in a particle size preferably not exceeding 25 mm. This system may be in the form of a slow two-axis knife mill served by a loading hopper ensuring protection of the operator.

It may also comprise a preheating and mixing system which may be made in the form of a water bath or any other equivalent device loaded by gravity with organic substrates and raw compost derived from the mill and receiving the dilution liquid consisting of percolates.

It may also include a lift pump accepting highly turbid flows with a maximum particle size of 35 mm is provided to supply the bioreactor at the upper portion.

It may also comprise a network of sensors capable of and configured to measure, in real-time or with a slight delay time, the values of the temperature, the pH, the turbidity of the digestates during the different phases, the chemical composition, the temperature and the relative humidity of the biogas and of the purified biomethane.

In one embodiment, the plant according to the invention comprises a plurality of sensors configured to deliver data, installed in the chambers of the anaerobic digestion unit, and in that said plant is configured to exploit said data in real-time and at each step of the anaerobic digestion process to inject determined amounts of humic percolates.

It is also possible to provide for a set of several programmable logic controllers configured to process the signals received from the sensors, analyze the behavior of effectors and report on the state of the system on a remote control station.

It is also possible to provide for a network of effectors such as hydraulic or pneumatic solenoid valves which can regulate the circulation of the flows of substrates, digestates, eluates; these devices are controlled by programmable logic controllers or directly by the human operator.

It is possible to provide for one or more tank(s) acting as bioreactors to accommodate the different phases of the biodigestion with the means for feeding and evacuating of the treated materials.

It is possible to provide for a system for degassing the digestates at the end of the methane digestion cycle. This system may be a simple gas-tight decantation chamber with or without specific intermixing devices.

In one embodiment, the plant according to the invention is configured to recirculate the percolates recovered at the lower portion of a composting chamber in said composting chamber in order to maintain the relative humidity level necessary for the composting phases, and for decanting and possibly stabilizing the humic percolates by air bubbling before recovery or reinjection thereof into the methane digestion chamber.

It is possible to provide for one or more biogas treatment device(s). In this respect, it is possible to provide for a biogas filtering device, intended to separate and treat CO₂ and CH₄, and which may be in the form of a cell for solubilization with water, solvents, reagents, osmotic filters or any other equivalent device. It is also possible to provide for a biogas dehumidification device to extract the water H₂O by condensation. It is possible to provide for a biogas filtering device to separate and treat hydrogen sulphide (H₂S), siloxanes and nitrogen oxides; this filtering device may be in the form of a capturing cell by biological means, activated carbon, or any other equivalent device.

The dimensioning of the plant according to the invention can be adapted to the needs of a site, within quite broad extents.

1-16. (canceled)

17. A continuous process for treating organic wastes, the process comprising:
conducting an anaerobic digestion process of a first part of the organic wastes in at least one digestion chamber;
conducting an aerobic composting process of a second part of the organic wastes in at least one composting chamber;
collecting, upon completion of the anaerobic digestion process, digestate and biogas;
collecting, upon completion of the aerobic composting process, compost and humic percolates;
feeding at least part of the digestate is fed into the aerobic composting process; and
feeding at least part of the humic percolate into the anaerobic digestion process.

18. The continuous process of claim 17, further comprising feeding part of the humic percolate into the aerobic composting process.

19. The continuous process of claim 17, wherein a first part of the organic wastes primarily includes volatile organic wastes selected from a group formed by: slaughterhouse wastes, dairy wastes, winemaking wastes, fish processing wastes, meat processing wastes, stable livestock wastes, kitchen and table wastes, and organic wastes originating from the agri-food industries.

20. The continuous process of claim 19, wherein a second part of the organic wastes primarily includes structuring organic wastes, mainly including organic polymers of a lignin, cellulose, hemicellulose, and/or keratin type.

21. The continuous process of claim 19, wherein a second part of the organic wastes primarily includes wastes selected from a group formed by: sawmill wastes, shredded forest wastes, shredded wood wastes or products, brown cardboard, shredded plants, collection of dead leaves, and agricultural wastes.

22. The continuous process of claim 17, wherein:
the at least one composting chamber includes a first heat exchanger operable to heat a heat-transfer fluid to a first temperature, and/or
the at least one digestion chamber includes a second heat exchanger operable to heat the at least one digestion chamber by the heat-transfer fluid at a second temperature that is lower than the first temperature.

23. The continuous process of claim 21, wherein at least part of the heat-transfer fluid heated by the first heat exchanger is conveyed into the second heat exchanger.

24. The continuous process of claim 17, wherein the biogas, preferably after at least one purification step, supplies fuel to a burner provided with a fourth heat exchanger which heats a heat-transfer liquid, which is in thermal communication with the second heat exchanger and/or the third heat exchanger.

25. The continuous process of claim 17, wherein the burner is in energy communication with an electrical energy generator, which preferably supplies electrical energy to at least one portion of the plant.

26. The continuous process of claim 19, further comprising, before cooling a first part of the organic wastes and inputting the first part of the organic wastes into the anaerobic digestion chamber, subjecting the first part of the organic wastes to a thermal pretreatment in a thermal pretreatment chamber at a temperature between 50° C. and 80° C., the thermal pretreatment chamber including with a third heat exchanger.

27. A treatment plant for implementing the continuous process of claim 17, the treatment plant comprising:
an anaerobic digestion unit operable to treat of a first part of the organic wastes for production of digestate and biogas, the anaerobic digestion unit having a plurality of chambers that includes a first chamber operable to conduct hydrolysis and acidogenesis, a second chamber operable to conduct the acetogenesis, a third chamber operable to conduct methanogenesis, and a fourth chamber operable to conduct degassing, the plurality of chambers being in fluidic connection to enable a transfer of treated wastes from one chamber to another chamber;
an aerobic composting unit having a composting chamber operable to conduct the aerobic composting of a second part of the organic wastes for production of compost and humic percolates;
a first transfer device operable to transfer the digestate from the fourth chamber to the aerobic composting unit; and
a second transfer device operable to transfer the compost and the percolates to the anaerobic digestion unit.

28. The treatment plant of claim 27, further comprising a third transfer device operable to transfer the humic percolate into the composting chamber.

29. The treatment plant of claim 27, further comprising a thermal pretreatment chamber disposed upstream of the anaerobic digestion unit so that the first part of the organic wastes operable to enter the anaerobic digestion unit passes through the thermal pretreatment chamber.

30. The treatment plant of claim 27, further comprising:
heating at least one of the chambers of the anaerobic digestion unit using a heat-transfer liquid;
heating the thermal pretreatment chamber using a heat-transfer liquid;
cooling the aerobic composting chamber by a heat-transfer liquid;
heating, using the heat recovered from the aerobic composting chamber, at least one of the chambers of the anaerobic digestion unit; and/or
heating the thermal pretreatment chamber using a heat-transfer liquid.

31. The treatment plant of claim 30, further comprising a burner operable to burn an energy fraction of the biogas produced by the anaerobic digestion chamber, and also heat a heat-transfer fluid which is in thermal communication with at least one of the chambers of the anaerobic digestion unit and/or with the thermal pretreatment chamber.

32. The treatment plant according to claim 31, wherein the burner is associated with an electrical energy generating device operable to supply electrical energy to the treatment plant.

33. The treatment plant according to claim 27, further comprising a plurality of sensors configured to deliver data in real-time, installed in the chambers of the anaerobic digestion unit, determined amounts of the humic percolates being injected during the anaerobic digestion process based on the data.

34. The treatment plant of claim 33, wherein the humic percolates recovered at a lower portion of the composting chamber are recirculated in order to maintain a relative humidity level necessary for composting.

35. The treatment plant of claim 33, wherein the humic percolates recovered at a lower portion of the composting chamber are decanted and stabilized by air bubbling before recycling them or reinjecting them into a digestion chamber.
